(19) United States
(12) Patent Application Publication
(10) Pub. No.: US 2010/0300811 A1
(43) Pub. Date: Dec. 2, 2010

(54) LUBRICANT APPLICATOR

(75) Inventor: Christopher Brink, Hamilton, OH (US)

Correspondence Address: Diversey, Inc., 8310 16TH STREET, M/S 509, PO BOX 902, STURTEVANT, WI, 53177-0902, US

(73) Assignee: DIVERSEY, INC., Sturtevant, WI (US)

(21) Appl. No.: 12/745,430

(22) PCT Filed: Nov. 25, 2008
(86) PCT No.: PCT/US08/84702

§ 371 Date: May 28, 2010

Related U.S. Application Data
(60) Provisional application No. 60/991,254, filed on Nov. 30, 2007.

(51) Int. Cl. B65G 45/02

(52) U.S. Cl. 184/15.2; 184/15.1

(57) ABSTRACT

A lubricant applicator includes a plurality of applicator bodies fixed to a common manifold. A nozzle from the manifold into the applicator body directs lubricant to a reservoir which allows the lubricant to drip onto the moving conveyor. A spreader bar is used to ensure that the entire cross section of the conveyor run is coated with the lubricant. The amount of lubricant injected into the reservoir is adjusted by selecting a nozzle with an appropriately sized orifice. Thus, a separate applicator can be used for each chain of a multi-chain conveyor and the amount of lubricant for each chain can be precisely controlled using a single manifold controlled by a single solenoid valve.

### BACKGROUND

In many applications, lubricant must be applied on the surface of conveyors, in particular, bottling lines which convey bottles to filling stations, capping stations and packaging stations. Many conveyors used in bottling lines have several narrow conveyor runs or chains that generally operate side by side at the same speed. In order to prevent the bottles or other containers from tipping over, a lubricant is typically applied to the surface of each conveyor chain. The lubricant must be uniformly applied over the surface of the conveyor system.

One way to achieve this uniform application of lubricant is to spray a diluted solution of the lubricant onto the conveyor. This provides even distribution of the lubricant but creates a great deal of waste. Excess lubricant simply drips off the conveyor where it must be collected and disposed.

To avoid waste and reduce overall volume, dry or undiluted lubricant can be applied to the conveyor system. Less undiluted lubricant is applied than would be applied with a diluted lubricant. Therefore, less lubricant drips off the conveyor reducing the waste disposal problem. Because less lubricant is applied, it is difficult to achieve the uniform dispersion of the lubricant across the conveyor surface. There have been many ways suggested to deal with this. Atomization of the lubricant using a separate air spray has been suggested. Applying the lubricant with a brush-type apparatus has also been employed.

Frequently, the separate narrow conveyor chains do not have the same length. Moving the containers at different angles requires the outer run of the conveyor system to be longer than the inner run of the conveyor system. Thus, if the lubricant is applied continuously in the same manner from either a spray or a brush, more lubricant per linear foot will be applied to the shorter run than to the longer run. Individually controlled sprayers could be used for each run of the conveyor but this would be excessively expensive and difficult to control.

### SUMMARY OF THE INVENTION

The present invention is premised on the realization that a lubricant applicator that has a reservoir that allows lubricant to drip onto the conveyor can be used to apply lubricant uniformly across a conveyor run and control the amount of lubricant applied. More particularly, the lubricant applicator employs a lubricant supply source, such as a spray nozzle or metering port attached to a manifold, to spray the lubricant into the reservoir. The reservoir includes one or more holes or openings which permit the lubricant to drip through the reservoir onto the conveyor surface. Downstream of the reservoir is a spreader such as a flexible blade, roller, or brush which ensures that the drips of lubricant uniformly coat the conveyor surface. A separate applicator is fixed above each individual conveyor run. The amount of lubricant applied to each conveyor run is controlled by selecting an appropriate nozzle fixed to a common manifold. An applicator resting above a shorter run would have a nozzle with a smaller orifice, whereas an applicator above a longer conveyor run would have a nozzle with a larger orifice to spray more lubricant into the respective reservoir which would continue to drip as the longer conveyor moves.

The objects and advantages of the present invention will be further appreciated in light of the following detailed description and drawings in which:

### BRIEF DESCRIPTION OF THE DRAWINGS

FIG. 1 is a side view of a conveyor system utilizing the applicator of the present invention.

FIG. 2 is an overhead view of a conveyor system with multiple runs and multiple applicators.

FIG. 3 is a perspective view partially broken away of a lubricant applicator according to the present invention.

FIG. 4 is a side view of the applicator shown in FIG. 3 partially broken away.

### DETAILED DESCRIPTION

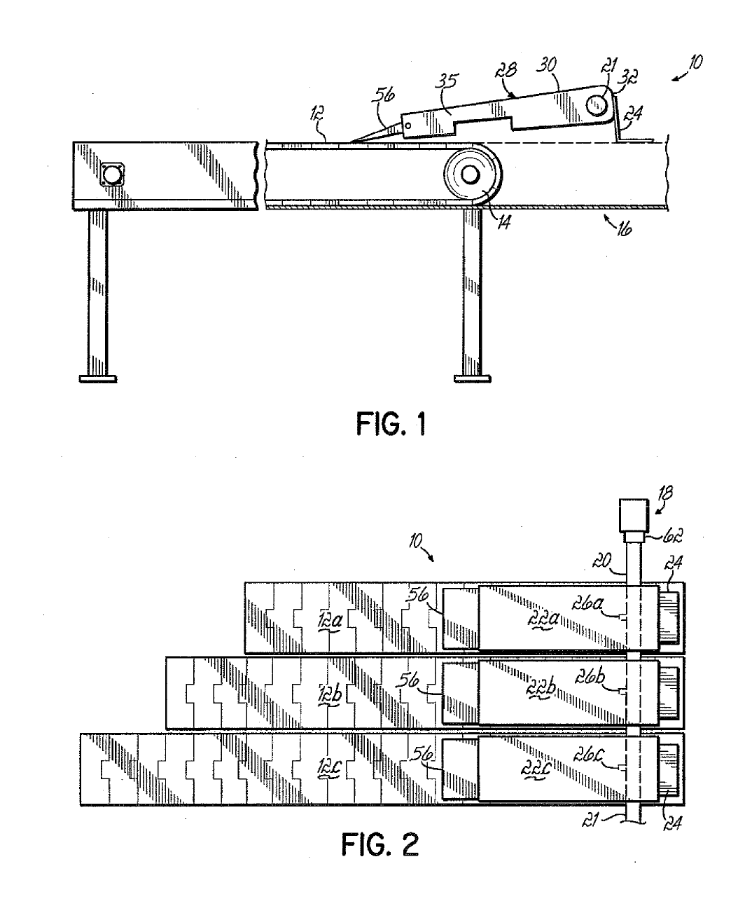

As shown in FIGS. 1 and 2, conveyor system 10 includes a plurality of chains or runs 12a, 12b, 12c (three shown) which are driven and supported by a drive roller 14 supported on conveyor frame 16.

The conveyor system 10 includes a lubricant dispensing system 18 which includes a pressurized manifold 20 closed at end 21 extending through a plurality of dispensers 22a, 22b, 22c, one each for each of the chains or runs 12a, 12b, 12c.

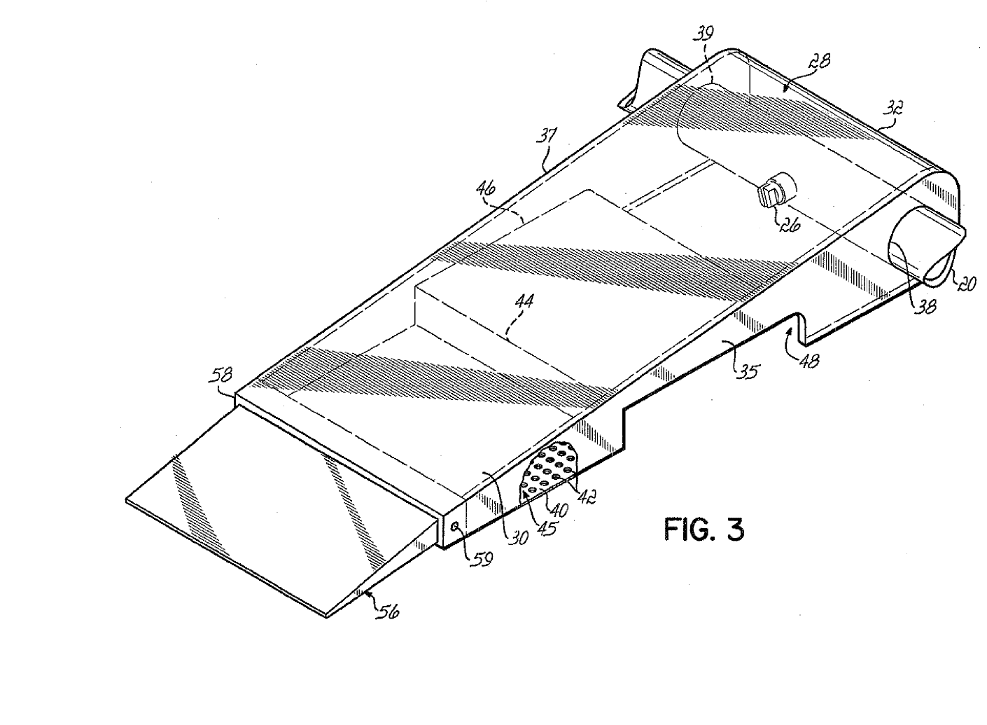

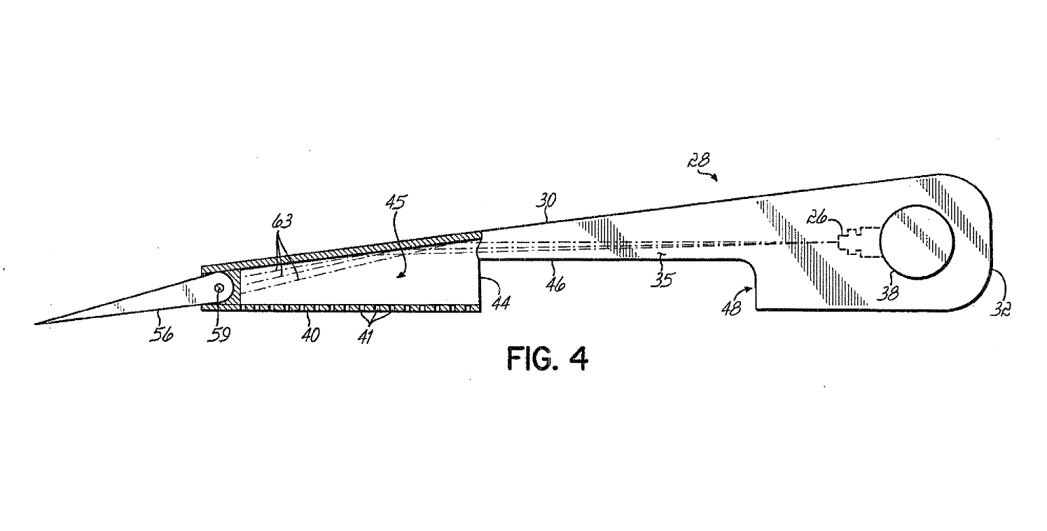

The dispensers 22a, 22b, 22c each include a dispenser body 28 (see FIGS. 3 and 4) which is supported by an L-bracket 24 bolted to frame 16. Located within each dispenser is a nozzle 26a, 26b, 26c, respectively, extending from the manifold 20.

The dispenser body 28 includes a top wall 30 and a back 32 which is bolted to the L-bracket 24. The body 28 further includes a front portion 36 and two opposed side walls 35, 37. Side walls 35,37 each include a circular opening 38, 39 adapted to receive the manifold 20.

Body 28 includes a forwardmost base section 40 which includes a plurality of perforations 42. As shown, the perforations are uniformly spaced along the base 40. The size, shape and location of the perforations will be determined by the desired rate of lubricant application as explained hereinafter.

Rearwardly of base 40 is a step or barrier 44 which leads to an intermediate planar portion 46. The barrier 44 creates a lubricant reservoir 45 above base section 40. Rearward of the planar portion 46 is an open portion 48 which allows access to the interior of the body 28 permitting one to attach nozzles 26 to manifold 20. The planar portion 46 is sloped slightly towards the base portion 40.

A flexible spreader 56 is fixed to the forward tip 58 of body 28 by a rod 59 extending through side walls 35, 37. As shown, this is a blade. But, it can be any type of spreader, including a brush.

As shown more particularly in FIGS. 1 and 2, the manifold 20 extends through the respective openings 38, 39 in each dispenser. One dispenser is supported above each chain or run 12a, 12b, 12c of the conveyor 12 with the flexible blade 56 of each applicator resting on the conveyor chains 12a, 12b, 12c and acting as spreaders to spread lubricant across the surface of chains 12a, 12b, 12c.

To install the dispensers, the manifold is extended through openings 38, 39 of each dispenser. Nozzles 26a, 26b, 26c are then positioned in apertures in the manifold. The nozzles are selected to ensure that the appropriate amount of lubricant is applied to the chain. This is done by selecting a nozzle with an appropriately-sized orifice. For example, because chain 12a is shorter than 12c, the orifice in its nozzle 26a should be smaller than the orifice in nozzle 26c. Thus, more lubricant is sprayed through nozzle 26c than 26a because both nozzles are attached to common manifold 20 and nozzle 26c has a larger orifice. The dispensers are then bolted to the L-brackets 24 with the flexible blade 56 resting on the surface of chains 12a, 12b, 12c. Finally, the manifold 20 is connected to a source of pressurized lubricant via solenoid 62.

In operation, solenoid 62 opens and pressurized lubricant flows through manifold 20 and is sprayed simultaneously through all of the nozzles 26a, 26b, 26c. The particular lubricant selected can be any lubricant suitable for use in chain lubrication. Typically, this will be what is referred to as a dry lubricant, one that is not diluted with water. These can include a wide variety of chemicals such as surfactants and fatty acids and the like. Selection of the appropriate lubricant is not considered a part of the present invention.

As shown in FIG. 3, lubricant 63 is emitted from the nozzles and sprays over the planar portion 44 into the reservoir area 45 immediately above the perforated forward surface 40. The solenoid 62 controls the duration of spray. The orifice size for each nozzle 26, in combination with the pressure of the lubricant 63 through manifold 20 and the time solenoid 62 is open, determines the amount of lubricant that is sprayed into each reservoir area 45. The lubricant then drips through the perforations 42 onto the conveyor system. The flexible blade 56 acts as a spreader ensuring that the entire cross section of each chain or run 12a, 12b, 12c is coated with the lubricant.

A variety of different spreaders can be employed, either fixed to the body 28 or fixed to the frame 16 of the conveyor. These can include, for example, a roller, a brush or even an air spray directed at the lubricant which is dripped onto the conveyor surface. Further, the Figures show an applicator wherein the lubricant 63 is sprayed from the rear of the applicator to the reservoir area. The manifold 20 can be located in a variety of locations as long as it can communicate with each reservoir through a separate nozzle or injector. For example, the manifold can be located above the reservoir and inject the lubricant downwardly. Further, the applicator bodies can be joined together as long as the reservoirs are separated to prevent lubricant flow from one reservoir to another.

As described above, the present invention provides a very simple mechanism to ensure that the appropriate amount of lubricant is applied for each run of a conveyor regardless of the length of the conveyor. This allows the appropriate amount of lubricant to be applied from a single manifold controlled by a single solenoid acting at one pressure. By changing the orifice size of the spray nozzle, the appropriate amount of lubricant is sprayed into a reservoir. The size and number of perforations or openings in the reservoir then ensure that the lubricant drips consistently onto the conveyor as it moves ensuring that the entire conveyor run is coated with the lubricant and without applying and thereby wasting excess lubricant.

This has been a description of the present invention along with the preferred method of practicing the present invention. However, the invention itself should only be defined by the appended claims wherein we claim:

What is claimed is:

1. A conveyor lubricant applicator comprising a lubricant body fixed above a conveyor, said applicator body having a lubricant reservoir, said reservoir having a base, and said base having at least one hole;
a lubricant supply in communication with said reservoir;
a spreader in spaced relationship to said at least one hole.

2. The lubricant applicator claimed in claim 1 wherein said base includes a plurality of holes.

3. The lubricant applicator claimed in claim 1 wherein said lubricant supply comprises a spray of lubricant extending through a spray nozzle.

4. The lubricant applicator claimed in claim 3 wherein said spray nozzle is spaced from said reservoir.

5. The lubricant applicator claimed in claim 1 wherein said applicator body includes a barrier between said spray nozzle and said reservoir and further includes an upper wall wherein said upper wall is spaced above said barrier.

6. The lubricant applicator claimed in claim 5 Wherein said barrier includes a planar surface.

7. The lubricant applicator claimed in claim 1 wherein said spreader is one of a solid flexible blade or a brush.

8. A plurality of conveyor lubricant applicators as claimed in claim 1 wherein said lubricant applicators are fixed one each above one of a plurality of conveyor belt runs with said spreaders of said applicators contacting said conveyor belt runs and wherein a common lubricant manifold communicates with each of said lubricant applicators through a separate nozzle fixed to said manifold for each of said applicators.

9. The lubricant applicator claimed in claim 8 wherein said nozzles each have an orifice and wherein the orifices are not all the same size.

10. A method of applying lubricant to a conveyor comprising injecting said lubricant into a reservoir positioned above said conveyor and allowing said lubricant to drip onto said conveyor as said conveyor moves and further comprising pressing said lubricant dripped onto said conveyor with a spreader to evenly spread said lubricant across said conveyor.

11. The method claimed in claim 10 wherein said lubricant is spread with a flexible blade pressed against said conveyor.

12. A method of applying lubricant to a plurality of belts of a conveyor system running parallel adjacent each other comprising:
spraying lubricant from a common manifold through a plurality of nozzles, each nozzle spraying into a separate reservoir;
each reservoir positioned above a separate run of said conveyor system;
allowing said lubricant to drip onto said conveyor as said conveyor moves.

13. The method claimed in claim 12 further comprising spreading said lubricant dripped onto said conveyor across said runs of said conveyor.
